(19) United States
(12) Patent Application Publication
(10) Pub. No.: US 2008/0044032 A1
(43) Pub. Date: Feb. 21, 2008

(54) METHOD AND SYSTEM FOR PROVIDING PERSONALIZED SERVICE MOBILITY

(75) Inventors: Dafu Lou, Nepean (CA); Tet Hin Yeap, Ottawa (CA); William G. O'Brien, Mississauga (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: BCE INC., Montreal, QC (CA)

(21) Appl. No.: 11/559,553

(22) Filed: Nov. 14, 2006

(30) Foreign Application Priority Data
Nov. 14, 2005 (CA) 2526791

(51) Int. Cl. H04L 9/00

(52) U.S. Cl. 380/284

(57) ABSTRACT

A method for securely transporting personalized service policies from a trusted home SIP server to an un-trusted host server, through a hostile environment, such as the Internet, using identity-based encryption. A user is able to define an instance-based encryption seed for a public key to be used in encryption of SIP, or other open signaling protocol, personalized services, including defining the time and the location at which the public key is to be valid. The method consists of encrypting, in accordance with instance-based parameters, personal profile information describing the personalized service policies; retrieving the encrypted personal profile information at the un-trusted host server; and decrypting the encrypted personal profile information if the instance-based parameters are satisfied.

### FIELD OF THE INVENTION

The present invention relates generally to providing personalized service mobility. More particularly, the present invention relates to securely transmitting personal profile information over a network implementing signaling protocol, such as Session Initiation Protocol (SIP).

### BACKGROUND OF THE INVENTION

SIP is an Internet Engineering Task Force (IETF) peer-to-peer, signaling protocol that facilitates openness, connectivity, choice and personalization. Initially designed to support multicast applications, the simplicity, power and extensibility of SIP have lead to its rapid adoption for other uses, notably Voice over Internet Protocol (VoIP), and Instant Messaging (IM). SIP can set up and manage communication sessions, regardless of the media type (e.g. voice, text, video, or data). In addition to voice communication features, SIP enables new services that are difficult or impossible to provide in traditional telephony-centric systems, such as presence; mobility; user-defined personalized services; instant multimedia communications; advanced multimedia conferencing; and multiple devices.

The feature-rich environment provided by SIP permits users to personalize their services. Basic system services, such as sending call requests and replying to a call, are provided to all users. Only the basic system services will be provided if personal policies are not available. Personalized services, or policies, are associated with and owned by a particular user and are triggered only when the request is for the user. For example, a user can choose to reject calls from anonymous callers, or can prevent people at work from knowing her presence status outside of work hours. Services can be handled based on a user's presence status, time, location, address, or any combination, in both call-processing and presence systems, and a user can have multiple policies for different services.

Mobility of personalized services is highly desirable. Personalized services give great flexibility to users, and are important differentiators for service providers. However, the personalized service policies contain sensitive personal profile information that can be associated to particular users, and are, thus, confronted with privacy and security issues. Since SIP is an open protocol, where information is transmitted in the clear, a risk of identity theft exists, especially if a user is operating in an un-trusted, or hostile, host mobile environment. Generally, users only have a trust relationship with their own service provider. The transfer of unsecured personalized service policies over the Internet, or their receipt by an un-trusted service provider, exposes the personal information contained within them to security threats and attacks. One solution is to have users deploy personalized services only from their home server. However, this approach can introduce unacceptable time delays perceptible to the user.

SIP, and other open signaling protocols, such as H.323, have basic security features. However, these security features are typically only enabled in the communication layer (layer 1), not in the system service layer (layer 2) or personalized service layer (layer 3). The use of a Public Key Infrastructure (PKI) in the personalized service layer has been proposed. However, there is a heavy overhead associated with PKI-based encryption systems. Substantial additional resources, such as certificate authorities, complex key management structures, and additional trusted servers for generating public keys, are required. Users are also reluctant to adopt PKI-based encryption due to the burden of storing and managing keys. In addition, the private keys in a PKI-based system have long lifespans and can be open to malicious interception if used in a hostile environment, leaving personal profile information open to unauthorized decryption.

Therefore, it is desirable to provide a method and system that permits the secure mobility of personal profile information associated with personalized services. The personal profile information should only be accessible at a time and location specified by the user, and should not persist in an un-trusted environment once it is no longer required.

### SUMMARY OF THE INVENTION

In a first aspect, the present invention provides a method for securely transmitting personal profile information. The method commences with encrypting the personal profile information, stored in a first location, in accordance with instance-based parameters. The encrypted personal profile information is then received at a second location; and decrypted if the instance-based parameters are satisfied.

In accordance with a second aspect, the present invention provides a method for providing personalized service mobility over a packet-based network. The method comprises steps of defining a public key in accordance with instance-based parameters; encrypting a personalized services profile using the public key; transmitting the encrypted personalized services profile over the packet-based network; generating a private key in accordance with the public key; and decrypting the encrypted personal profile information with the private key if the instance-based parameters are satisfied.

In a third aspect, the present invention provides a system for transmitting personal profile information over a packet-based network. The system comprises a first user agent, a second user agent, and a private key generator. The first user agent stores personalized services policies and communicates with a server to encrypt, using identity-based encryption, the personalized policies in accordance with user-defined criteria. The second user agent, which is remote from the first user agent, receives the encrypted personalized service policies. The private key generator, which is in communication with the first and second user agents, generates a private key in accordance with the public key. The private key is adapted to decrypt the encrypted personalized services policies only when the user-defined criteria are satisfied.

In accordance with a fourth aspect, the present invention provides a user agent for securely deploying personalized services policies. The user agent comprises means for receiving a personalized services profile encrypted with a public key defined by instance-based parameters; means for receiving a private key generated in accordance with the public key; and a decryption engine to decrypt the encrypted personalized services profile if the instance-based parameters are satisfied.

In a fifth aspect, the present invention provides a method for securely deploying personalized services. The method comprises steps of receiving a personalized services profile encrypted in accordance with a public key; receiving a private key generated in accordance with the public key; decrypting the encrypted personalized services profile if instance-based parameters associated with the public and private keys are satisfied.

In embodiments of the present invention, the first location can be a trusted host environment, the second location can be a an un-trusted host environment, and the encrypted personal profile information can be transmitted over an un-trusted network. The private key can be generated from the second location by communicating with a private key generator. The packet-based network can implement such signaling protocols as SIP, H.323, or MEGACO/H.248. The personalized services profile information can be described in CPL.

In one embodiment, the encryption and decryption use an identity-based encryption method. The instance-based parameters can include a user-defined string or phrase and at least one constraint as a public key. The at least one constraint can be selected from the group consisting of time, date and location.

In a further embodiments, the personalized services can be activated in accordance with the decrypted personalized services profile. The private key can be made to expire when the instance-based parameters are no longer satisfied. The personal profile information can also be re-encrypted when the instance-based parameters are no longer satisfied.

In yet further embodiments, the decrypted personalized services policies are stored in a local database for access by the second user agent. The first and second user agents can include a SIP client, and can be resident on user devices, such as laptop computers, desktop computers, personal data assistants (PDAs), or SIP telephones.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows a three-layer SIP-based service architecture with a call-processing system;

FIG. 2 is a flowchart of a method for securely transporting personalized services according to an embodiment of the present invention; and

FIG. 3 is a diagram of an embodiment of a system for securely transporting personalized services according to the present invention.

### DETAILED DESCRIPTION

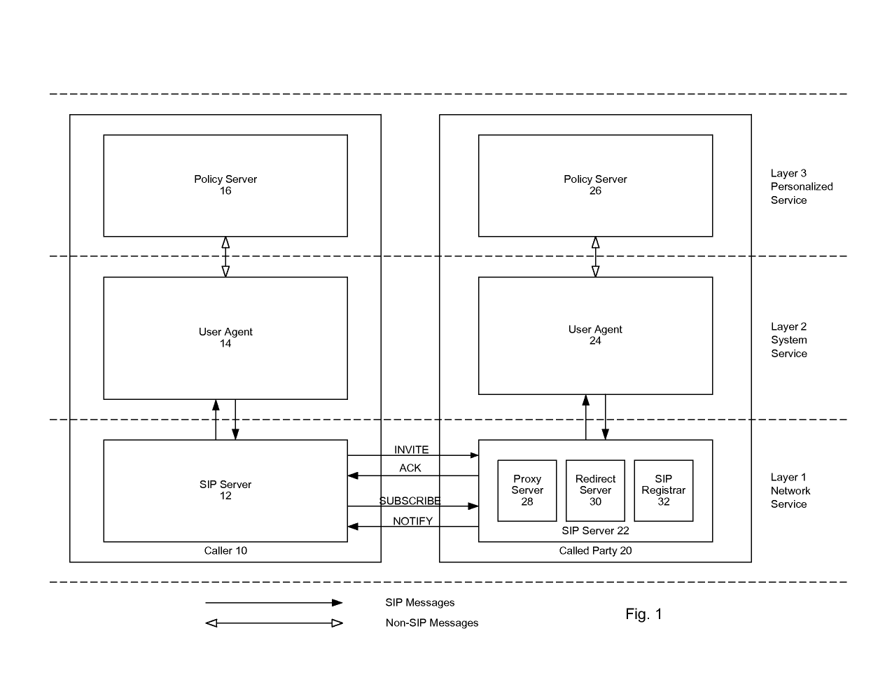

FIG. 1 depicts a three-layer SIP-based service architecture with a call-processing system. A caller side 10 and a called party side 20 are shown. Each of the caller 10 and called party 20 includes a SIP server 12, 22 in the network service layer (layer 1), a user agent 14, 24 in the system service layer (layer 2), and a policy server 16, 26 in the personalized service layer (layer 3). The user agents 14, 24 are endpoints in a SIP network. They originate and terminate calls, and initiate and terminate the media session (voice, video, data, etc.). User agents are software entities resident on hardware devices that can include: SIP phones (hard sets), laptop and desktop computers or PDAs with a SIP client (e.g., softphone), media gateways (e.g. T1/E1 gateway), access gateways (e.g., FAX gateway), and conferencing systems. The SIP servers 12, 22 can be any suitable computing device capable of interfacing with a packet-based network, such as a Transmission Control Protocol/Internet Protocol (TCP/IP) network.

The application software embodying the user agents and the server functionality can be provided on any suitable computer-useable medium for execution by a microprocessor in the user device, such as CD-ROM, hard disk, read-only memory, or random access memory. The application software can be written in a suitable programming language, such as C++. The user agents 14, 24 can be organized into various modules or engines, such as an module to receive a personalized services profile encrypted with a public key defined by instance-based parameters; a module to receive a private key generated in accordance with the public key, such as by communicating with a private key generator; and a decryption engine to decrypt the encrypted personalized services profile if the instance-based parameters are satisfied. Modules for activating the personalized services based on the decrypted personalized services profile, and for re-encrypting the profile once the private key expires, or otherwise, can also be provided.

As shown for SIP server 22, a SIP server can include a proxy server 28, a redirect server 30 and a SIP registrar 32. Proxy server 28 performs signaling and relay functions. In other words, it determines where to send signaling messages and forward requests on behalf of a user agent. To do so, it consults appropriate databases, such as Domain Name Servers (DNS) and location servers. Proxy servers have no media capabilities; they are in the control path only. Proxy servers can try several destinations sequentially or in parallel. This capability, called forking, enables multiple devices to be associated with the same address.

SIP registrar 32 accepts registration requests from users containing the users present location (i.e. 192.168.0.10) and maintains this location information. Mobility is thus enabled by the receipt of a REGISTER message from the user agent, and by keeping a location database updated. Redirect server 30 redirects SIP requests to another device. A redirect server responds to the request with the address to which the request should be redirected (e.g., a request for alice@work.com can be redirected to alice@home.com).

Personalized services, such as intelligent call forwarding and selective control of presence notification, are typically described in extended Call Processing Language (CPL). Personalized services in CPL and their mobility are independent of the signaling protocol, such as H.323 or SIP, used. These policies are associated with and owned by a particular user and triggered only when the request is for the user. The user agent is the intelligent central service controller representing the user and takes care of the CPL policies locally. Personalized services are programmed by end users, managed by policy servers 16, 26 and executed by user agents 14, 24.

SIP is designed so that user agents can discover and negotiate their capabilities. There are two types of SIP messages: SIP requests and SIP responses. SIP requests include: INVITE—to initiate a session; REGISTER—to bind a permanent address to a current location; SUBSCRIBE—to subscribe to a service state change; and NOTIFY—to notify a change of service state (e.g., new voice message). SUBSCRIBE is used for presence (e.g. to subscribe to an event and receive notification), call-back when other party becomes available, voice mail notification, or any event that can be associated with a trigger (e.g., stock quotes, etc.). NOTIFY works in parallel with SUBSCRIBE. SIP responses are numeric codes set out in the appropriate standards. A SIP message can also contain media session information in Session Description Protocol (SDP), which determines on what type of media (e.g. audio, video, etc.) the communication session will be realized.

To make a VoIP phone call, for example, user agent 14 sends an INVITE request, via SIP server 12. In the message body, the user agent specifies the type of media available. The outbound proxy server 28 routes the request across the network until it reaches its destination. When the proxy server 28 receives the INVITE request, it determines if it can accept the call in which case, it will ring the user agent 24 and send a provisional response back to the caller to indicate that the phone is ringing.

When the called party answers, the called user agent 24 sends a final response with the media channels that it can support. Both parties agree on a media channel, and the called user agent 24 sends an acknowledgment to the caller user agent 14. Once a SIP session is established, the real time media inputs are sampled, converted to digital format, encapsulated in Real Time Protocol (RTP), and delivered via User Datagram Protocol (UDP), or TCP, directly in a peer-to-peer manner.

As noted above, SIP allows users to be mobile with a single published SIP address by maintaining their current location information in the registrar server 32. Service mobility can be provided, if a user can access the same basic and personalized services from different locations and with different devices. Personalized service mobility can be achieved by moving a user's CPL policies to a policy server at the new location, rather than forcing the user agent to access the policies directly from the user's home server.

The present invention provides a system and method for securely transporting the personalized service policies from a trusted home SIP server to a un-trusted host server, through a hostile environment, such as the Internet. Broadly, the present invention allows a user to define an instance-based encryption seed for a public key to be used in encryption of SIP, or other open signaling protocol, personalized services, including defining the time and the location at which the public key is to be valid. The method consists of encrypting personal profile information describing the personalized service policies in accordance with instance-based parameters; retrieving the encrypted personal profile information at the un-trusted host server; and decrypting the encrypted personal profile information if the instance-based parameters are satisfied. In a presently preferred embodiment, the instance-based encryption is identity-based encryption (IBE).

IBE is an asymmetric cryptographic encryption method that allows a user to generate a public key from a known identity value or shared secret, such as an ASCII string or phrase defined by a user. A trusted third party, called the Private Key Generator (PKG), generates the corresponding private keys on demand using the same known identity value and a seed value uniquely associated with the identity of the intended receiving party. As a result, users can encrypt messages with no prior distribution or storage of keys. The user defining the public key can also define further constraints, such as time, date and location, under which the generated private key will be valid. The first identity-based cryptography method was a signature scheme developed by Shamir in 1984. Common methods in use today include Boneh/Franklin's pairing-based encryption method, and Cocks' encryption method based on quadratic residues. The most efficient identity-based encryption methods are currently based on bilinear pairings on elliptic curves, such as the Weil or Tate pairings.

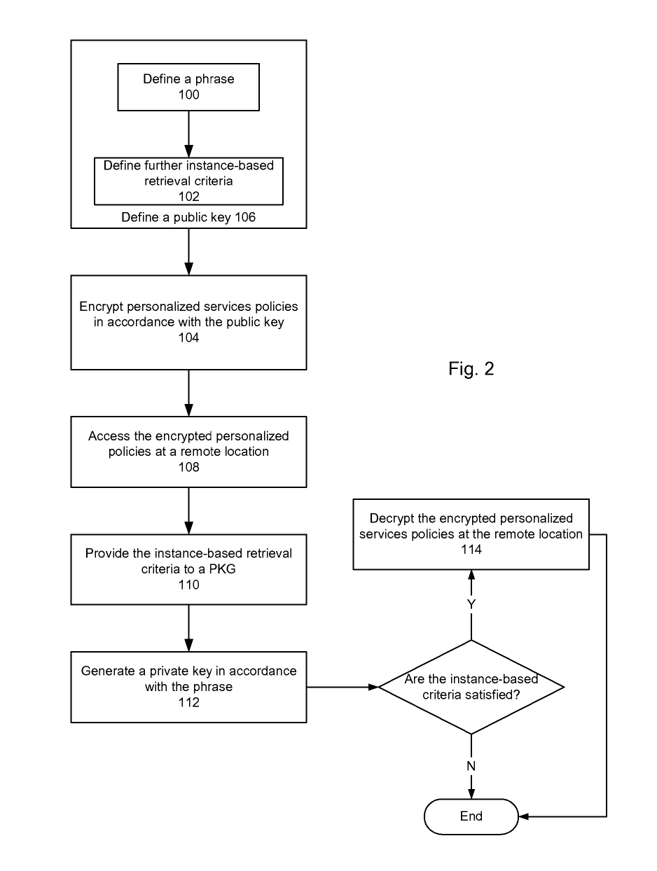

According to an embodiment of the present invention, and referring to FIG. 2, the user, at a trusted home server, defines an ASCII string or phrase to encrypt information to transmit user settings in a SIP environment between different service providers (100). The user is also able to define location, time and other instance-based retrieval criteria, or constraints, under which the personal information can be decoded (102). The information is then encrypted and transmitted to a host server (104) at a second location.

Upon arrival at the new location, the user accesses and authenticates herself to the trusted visited server, including providing the pre-defined phrase (108). The visited server then accesses the home server and provides instance-based parameters (110), including the phrase provided by the user, a seed value uniquely associated to the user, and the necessary constraint values, such as location and time. If the provided phrase matches the user-defined string used to define the public key, the home server instructs a PKG to generate a private key based on the instance-based parameters (112). The private key is then stored on the visited server (114) and can be used to decrypt the personalized service information (116). The key can only be used to decrypt the personalized information under the constraints previously defined by the user. Effectively, the key is single use, since it expires and cannot, for example, be reused at a different location or time. Multiple instances of a user's policies can be created and encrypted, each with a different phrase and/or constraints, for a variety of locations or time periods.

The implementation of the present IBE-based scheme for personalized service mobility can be described more formally in five stages. In the first stage, the IBE system parameters are set and a master PKG key is created. This setup phase consists of the following steps:
(1) Given a security parameter kεZ⁺, run a bilinear Diffie-Hellman parameter generator on input k to generate a prime q, two groups G₁, G₂ of order q, and an bilinear map ê: G₁×G₁→G₂. Pick an arbitrary prime PεG₁.
(2) Choose a random sεZ_{q}* and set P_{pub}=sP.
(3) Choose two cryptographic hash functions H₁:{0,1}*→G₁*, and H₂:G₂*→{0,1}ⁿ where nεZ⁺. The message space is M={0,1}ⁿ. The cipher text space is C=G₁^{*}×{0,1}. The system parameters are then
   params= [symbol] q,G₁,G₂,ê,n,P,P_{pub},H₁,H₂ [symbol] . The master key is sεZ_{q}*.

In the second stage, according to desired security requirements, the security policies for how to choose a public key string are defined: IDε{0,1}ⁿ

In the third stage, the personalized service policies are encrypted for transportation. To encrypt mεM under ID:
(1) Compute Q_{ID}=H₁(ID)
(2) Choose a random rεZ_{q}*
(3) Set the ciphertext to be C= [symbol] rP,m⊕H₂(g_{ID}^{r}) [symbol] where g_{ID}=ê(Q_{ID},P_{pub})εG₂*.

In the fourth stage the policy owner is authenticated and the PKG generates his private key. For a given ID:
(1) Compute Q_{ID}=H₁(ID)εG₁*,
(2). Set the private key d_{ID} to be d_{ID}=sQ_{ID}, where s is the master key.

Finally, in the fifth stage, the personalized policies are decrypted at the user's request. Let C= [symbol] U,V [symbol] be a ciphertext. To decrypt C using the private key d_{ID} compute: V⊕H₂(ê(d_{ID},U))=m

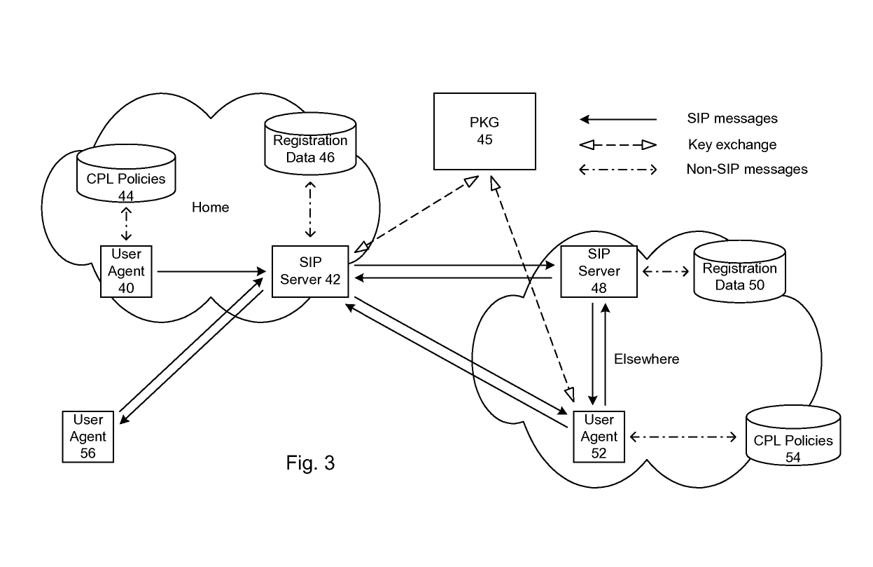

An embodiment of the system of the present invention and an example of its operation is shown in FIG. 3. Alice, a user normally resident at Home, is planning to visit Elsewhere, a location hosted by an un-trusted service provider. Alice has programmed personalized services at Home. Alice's user agent 40 stores a policy copy locally in a CPL policies database 44, and the Home SIP server 42 retains another copy in a local database 46 for registration data. Alice wishes to enable at least some of her personalized services while she is in Elsewhere. Alice has published a single SIP address, alice@home.com, and programmed a call forwarding service that forwards calls from her boss, Bob, only during work hours. She would like to have this same functionality when she is in Elsewhere, where she will be using a device having an address of alice@elsewhere.com.

Alice registers herself, and her personalized policies, for service mobility via her user agent 40 to her trusted home server 42, the Home SIP server. She sets her security policies to determine how public keys will be generated. For example, Alice wants her keys to be valid only for her stay in Elsewhere. For example, her public key can be set as: “alice@elsewhere.com|arrival date|departure date|location”, where alice@elsewhere.com is her user-defined phrase, and the arrival and departure dates, and location, are further constraints. The home SIP server 42, which is programmed to provide identity-based encryption, uses the user-defined public key to encrypt Alice's call forwarding policy and passes her public key to the trusted PKG 45.

When Alice arrives in Elsewhere, she registers herself—alice@elsewhere.com—to the Elsewhere SIP server 48, and registers to the Home SIP server 42 with her Elsewhere address—alice@elsewhere.com—as a forwarding address. Alice's elsewhere address is also stored in local registration data database 50. The Elsewhere SIP server 48 obtains Alice's encrypted personalized policies and sends them to her Elsewhere user agent 52. The encrypted policies can, prior to Alice's departure, be pushed to the Elsewhere SIP server 48, or they can be pulled by server 48 once she has authenticated to that server. In either case, the encrypted policies are sent to the server 48 under SIP. Only the payload of the SIP message is encrypted; the message itself is sent in the clear with standard SIP headers and routing information.

After Alice's successful registration and authentication, her local user agent 52 requests a private key from PKG 45, and passes a phrase input by Alice, her location, and the current date to the PKG. PKG 45 generates a private key if the phrase matches Alice's previously defined phrase, and sends it to user agent 52. Agent 52, which is programmed to provide identity-based decryption, then decrypts the encrypted personalized policies using the private key, which will only work if the date and location constraints are also met. The decrypted policies are then saved locally in a CPL policies database 54. Alice's policies are secure at the un-trusted Elsewhere host, since they exist, in their decrypted form, only in Alice's local CPL storage database 54. Preferably, the policies are re-encrypted with Alice's public key once their defined validity period has elapsed. This prevents her Elsewhere user agent 52, or any other entity, from accessing them outside of the period specified by her security policies.

When Alice is in Elsewhere, Bob initiates a call to Alice's public address alice@home.com after work hours. The Home SIP server 42 receives Bob's call request, checks Alice's registration in the database 46, and forwards the request to alice@elsewhere.com. The Elsewhere SIP server 48 looks up alice@elsewhere.com in the database 50, which returns the address of user agent 52. The Elsewhere SIP server 48 then sends a call request to user agent 52, which has access to Alice's decrypted and locally stored personalized service policies. User agent 52 retrieves Alice's call forwarding policy from the local CPL policies database 54, executes it, and returns a rejection of Bob's request to Bob's user agent 56.

While the above-described embodiments have been described in relation to a TCP/IP network implementing SIP, the present invention can be used in any packet-based network and with any signaling protocol, particularly those with an open protocol stack for information transfer, such as H.323 developed by the International Telecommunication Union Telecommunication Standardization Sector (ITU-T), Media Gateway Control Protocol (MGCP) and Megaco/H.248 jointly developed by the IETF and ITU-T. Cryptographic methods, other than IBE, are also contemplated under the present invention, provided they can be adapted to provide instance-based decryption.

In summary, the present invention uses IBE to protect personal policies and provide service mobility in any un-trusted environment. Using this instance-based, asymmetrical cryptography provides a high level of security and encourages adoption by users, since complex key management and distribution are avoided. Users can define and manage their own security policies, opening up a new area for personalized security related services and moving responsibility and liability for securing the data from the service provider to the user.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for securely transmitting personal profile information, comprising:
encrypting the personal profile information, stored in a first location, in accordance with instance-based parameters;
retrieving the encrypted personal profile information at a second location; and
decrypting the encrypted personal profile information if the instance-based parameters are satisfied.

2. The method of claim 1, wherein the first location is a trusted host environment.

3. The method of claim 1, further including transmitting the encrypted personal profile information over an un-trusted network.

4. The method of claim 1, wherein the second location is an un-trusted host environment.

5. The method of claim 1, wherein the encrypting and decrypting employ an identity-based encryption method.

6. The method of claim 5, wherein the instance-based parameters include a user-defined string and at least one constraint as a public key.

7. The method of claim 6, wherein the at least one constraint is selected from the group consisting of time, date and location.

8. The method of claim 6, wherein the decrypting includes generating a private key at the second location in accordance with the public key.

9. The method of claim 8, wherein the private key is valid only when the at least one constraint is satisfied.

10. The method of claim 9, further including re-encrypting the personal profile information when the private key expires.

11. The method of claim 1, further including activating, in accordance with the decrypted personal profile information, personalized services at the second location.

12. The method of claim 1, wherein personal profile information is retrieved over a network implementing Session Initiation Protocol (SIP).

13. The method of claim 1, wherein the personal profile information is described in Call Processing Language (CPL).

14. A system for transmitting personal profile information over a packet-based network, comprising:
a first user agent storing personalized services policies and communicating with a server to encrypt, using identity-based encryption, the personalized policies in accordance with user-defined criteria;
a second user agent, remote from the first user agent, to receive the encrypted personalized service policies; and
a private key generator, in communication with the first and second user agents, to generate a private key in accordance with the public key, the private key being adapted to decrypt the encrypted personalized services policies only when the user-defined criteria are satisfied.

15. The system of claim 14, wherein the second user agent operates in an un-trusted environment.

16. The system of claim 14, wherein the packet-based network implements SIP.

17. The system of claim 14, wherein the packet-based network implements H.323 protocol.

18. The system of claim 14, wherein the packet-based network implements Media Gateway Control Protocol (MGCP) or Megaco/H.248 protocol.

19. The system of claim 14, wherein the decrypted personalized services policies are stored in a local database for access by the second user agent.

20. The system of claim 14, further including means for re-encrypting the decrypted personalized services policies when the user-defined criteria are no longer met.

21. The system of claim 14, wherein the personalized services policies are described in CPL.

22. The system of claim 14, wherein the second user agent is installed in a user device.

23. The system of claim 22, wherein the user device includes a SIP client.

24. The system of claim 23, wherein the user device is selected from the group consisting of laptop computers, desktop computers, and personal data assistants.

25. The system of claim 22, wherein the user device is a SIP telephone.

26. A method for providing personalized service mobility over a packet-based network, comprising:
defining a public key in accordance with instance-based parameters;
encrypting a personalized services profile using the public key;
transmitting the encrypted personalized services profile over the packet-based network;
generating a private key in accordance with the public key;
decrypting the encrypted personal profile information with the private key if the instance-based parameters are satisfied.

27. The method of claim 26, wherein the instance-based parameters include a user-defined string.

28. The method of claim 26, wherein the instance-based parameters include at least one constraint of time, date, and location.

29. The method of claim 26, wherein the packet-based network implements SIP.

30. The method of claim 26, wherein the packet-based network implements H.323 protocol.

31. The method of claim 26, wherein the packet-based network implements MGCP or Megaco/H.248 protocol.

32. The method of claim 26, wherein the encrypted personalized services information is transmitted from a first location to a second location.

33. The method of claim 32, wherein the private key is generated from the second location.

34. The method of claim 32, wherein the first location is a trusted server and the second location is a un-trusted server.

35. A user agent for securely deploying personalized services policies, comprising:
means for receiving a personalized services profile encrypted with a public key defined by instance-based parameters;
means for receiving a private key generated in accordance with the public key; and
a decryption engine to decrypt the encrypted personalized services profile if the instance-based parameters are satisfied.

36. The user agent of claim 35, further including means for activating personalized services in accordance with the decrypted personalized services profile.

37. The user agent of claim 35, wherein the instance-based parameters include a user-defined phrase.

38. The user agent of claim 35, wherein the instance-based parameters include at least one constraint selected from time, date and location.

39. The user agent of claim 38, wherein the private key expires when the at least one constraint is invalid.

40. The user agent of claim 35, further including means to communicate with a private key generator to generate the private key.

41. The user agent of claim 40, further including means to transmit a user-defined phrase and at least one constraint to the private key generator.

42. The user agent of claim 41, wherein the at least one constraint is selected from time, date and location.

43. The user agent of claim 35, wherein the encrypted personalized services profile is received over a packet-based network.

44. The user agent of claim 35, wherein the packet-based network implements SIP.

45. The user agent of claim 35, wherein the packet-based network implements H.323 protocol.

46. The user agent of claim 35, wherein the packet-based network implements MGCP or Megaco/H.248 protocol.

47. A method for securely deploying personalized services, comprising:
receiving a personalized services profile encrypted in accordance with a public key;
receiving a private key generated in accordance with the public key;
decrypting the encrypted personalized services profile if instance-based parameters associated with the public and private keys are satisfied.

48. The method of claim 47, wherein encrypted personalized services profile are received in an un-trusted host environment.

49. The method of claim 47, wherein the personalized services profile is encrypted and decrypted using an identity-based encryption method.

50. The method of claim 47, wherein the instance-based parameters include a user-defined string and at least one constraint.

51. The method of claim 50, wherein the at least one constraint is selected from the group consisting of time, date and location.

52. The method of claim 47, wherein the decrypting includes generating the private key from a second location.

53. The method of claim 50, wherein the private key is valid only when the at least one constraint is satisfied.

54. The method of claim 47, further including re-encrypting the personal profile information when the private key expires.

55. The method of claim 47, further including activating, in accordance with the decrypted personalized profile, personalized services at the second location.

56. The method of claim 47, wherein the encrypted personalized services profile is received over a network implementing SIP.

57. The method of claim 47, wherein the encrypted personalized services profile is received over a network implementing H.323 protocol.

58. The method of claim 47, wherein the personalized services profile is described in CPL.
